(19) United States
(12) Patent Application Publication
(10) Pub. No.: US 2024/0367558 A1
(43) Pub. Date: Nov. 7, 2024

(54) DEVICE AND METHOD FOR DETECTING THE POSITION OF A VEHICLE SEAT

(71) Applicant: Polycontact AG, Chur (CH)

(72) Inventors: Stefan TANNO, Domat-Ems (CH); Reto HIDBER, Grüsch (CH); Dominik DORT, Flums (CH); Andrin BÜSSER, Chur (CH); Dorin BEU, Chur (CH); Thomas ZAUGG, Chur (CH)

(73) Assignee: Polycontact AG, Chur (CH)

(21) Appl. No.: 18/654,461

(22) Filed: May 3, 2024

(30) Foreign Application Priority Data
May 3, 2023 (CH) 000475/2023

(51) Int. Cl. B60N 2/02; B60N 2/06

(52) U.S. Cl. CPC B60N 2/0272; B60N 2/06

(57) ABSTRACT

A device and a method for detecting the position of a vehicle seat which can be linearly displaced along a seat rail (20) relative to a vehicle floor. The seat rail (20) has a first rail and a second rail which can be displaced relative to one another, in particular, an upper rail (21) and a lower rail (22). The device (100) has a first detection device (30), which is arranged on the first rail and a first permanent magnet (40) as well as a second permanent magnet (41), which are arranged on the second rail. The first permanent magnet (40) and the second permanent magnet (41) are spaced apart from each other and their magnetic poles are aligned in opposite directions.

This application claims priority from Swiss patent application serial no. 000475/2023 filed May 3, 2023.

### FIELD OF THE INVENTION

The present invention relates to a device and a method for determining the position of a vehicle seat that can be moved linearly along a seat rail relative to the vehicle floor, as well as a corresponding method according to the preamble of the independent claims.

### BACKGROUND OF THE INVENTION

Motor vehicles, especially passenger cars, are increasingly being equipped with safety devices such as front, side, knee and head airbags. These safety features are designed to protect the occupants in the event of a collision and reduce the risk of injury. Airbags must be deployed and inflated within a very short period of time. Typically, propellant charges are used that explosively inflate the airbag and cause it to emerge from the respective panel inside the vehicle.

The arrangement of the airbags and the choice of their size represents a compromise that is intended to do justice to the different sizes and weights of the vehicle occupants. Front airbags are often designed to inflate the airbag to different degrees depending on the seating position of the vehicle occupants. For example, a front airbag should inflate more strongly in the case of a tall occupant whose vehicle seat is positioned further away from the dashboard than in the case of a shorter occupant whose vehicle seat is moved to a position closer to the dashboard. This is intended to prevent a vehicle occupant closer to the dashboard from being injured by the force of an airbag inflating at full force. The inflation energy for the airbag is controlled, for example, by varying the amounts of the propellant charge that are ignited. To control the inflation energy for the airbag, it is therefore desirable to know the distance of the vehicle seat from the dashboard.

Various mechanical and electromechanical systems have therefore already been used in the past to determine the position of the vehicle seat. However, mechanical or electromechanical detector systems are susceptible to wear and tear and can lead to unpleasant, unwanted noises if the vehicle seat is adjusted.

In the course of increasing automation, motor vehicles are increasingly being equipped with electrical and electronic components that take over the function of the former mechanical or electromechanical sensor devices. From the existing state of the art, contactless sensor devices are also known, which can detect the relative position of two components that can be moved relative to each other, in order to generate a corresponding control signal.

In the case of the vehicle seat, for example, the components that can be moved relative to each other are a seat rail, comprising a lower rail mounted on the vehicle floor and an upper rail that is firmly connected to the vehicle seat and can be moved linearly along the lower rail. In general, the two rails, specifically the bottom rail and the top rail, are collectively referred to as the seat rail. Typically, a seat rail of this type is made up of two pairs of bottom rails and top rails. In most cases, however, the position is only evaluated based on one of the two pairs of top and bottom rails.

Typically, the position is currently detected when the distance between the vehicle occupant and the steering wheel is shortest. This is usually the position with the highest risk potential from the airbag. Once this position is vacated, the airbag deploys evenly over the remaining possible displacement distance of the vehicle seat. For this purpose, the currently known systems feature sensors that detect the foremost position or a foremost area of adjustment of a vehicle seat.

However, recent studies have shown that this type of two-stage control may be inadequate. If the occupant is far away, the distance to the airbag is longer. This may result in unfavorable effects on the vehicle occupants.

There are also known systems that continuously measure the position of a vehicle seat. In order to control a multi-stage airbag, a stage must be assigned to a specific displacement range. To realize this, a specific value range of an output signal must be assigned to this stage. This can lead to inaccuracies, particularly at the edge of the displacement range.

### SUMMARY OF THE INVENTION

It is therefore the task of the invention to provide a device and, in particular, a method which eliminates the disadvantages of the prior state of the art. In particular, it should be possible to control an airbag with different triggering characteristics depending on the different positions of a vehicle occupant.

This task is solved by the devices and methods defined in the independent patent claims. Further embodiments are shown in the dependent patent claims.

A device according to the invention for detecting the position of a vehicle seat that is linearly displaceable along a seat rail relative to a vehicle floor has a first detector device. The seat rail has a first rail and a second rail that can be moved relative to each other. The first rail and the second rail are designed, in particular, as a top rail and a bottom rail. The first detector device is arranged on the first rail. The device for detecting the position of the vehicle seat also has a first permanent magnet and a second permanent magnet, both of which are arranged on the second rail. The first permanent magnet and the second permanent magnet are spaced apart and their magnetic poles are aligned in opposite directions.

In this case, spaced apart means in the direction of displacement of the vehicle seat, i.e., along the seat rail or along its linear direction of displacement.

Preferably, a first permanent magnet is arranged at the rear of the seat rail and the second permanent magnet at the front of the seat rail. With regard to the seat rail, this typically comprises a pair of an upper rail and a lower rail. Of course, a seat rail includes a second pair consisting of an upper rail and a lower rail.

The arrangement of two permanent magnets with oppositely aligned magnetic poles makes it possible to generate two different signals on the same seat rail. In other words, two magnetic fields are provided here, which are aligned differently and can therefore also generate a different signal.

This makes it possible to read a corresponding position on the first permanent magnet, to read a corresponding position on the second permanent magnet, and to read a third position between the two permanent magnets. The permanent magnets make it possible to generate a positive signal and a negative signal according to the orientation of the field lines and the area in which there is no permanent magnet generates a neutral signal.

In other words, the device according to the invention is designed to detect several, in particular, at least three, preferably exactly three, discrete positions of a vehicle seat that can be moved linearly along a seat rail. In this case, the device is designed to detect three discrete positions, each corresponding to a different displacement range of the vehicle seat.

Since the same signal is generated or can be generated for an entire displacement range, a specific signal, rather than a signal range, needs to be assigned to a deployment stage of an airbag. In particular, the detection of a position is more distinct, because the signals make a jump from position to position.

In one embodiment, the first detection device can be designed as a linear Hall sensor or as a Hall sensor with two detection axes.

These Hall sensors make it possible to read out two different signals. In other words, the status of the two permanent magnets can be detected with Hall sensors of this type. Accordingly, two different signals can be transmitted to, or generated by, a corresponding control device, enabling the implementation of two states of the vehicle seat: a front position and a rear position. In addition, if the Hall sensor does not occupy one of the two permanent magnets, no signal is generated, whereby this “missing” signal can be used to control the airbag with a third state. This third state typically defines triggering under normal conditions. However, when the first permanent magnet is associated with the seat position “at the very front,” the airbag is deployed with reduced force, and when the second permanent magnet is associated with the seat position “at the very back,” the airbag is deployed with increased force.

In a further embodiment, the device can have a second detector device, which is arranged on the first rail.

A second detector device allows a separate signal to be generated independently of the first detector device and forwarded to a control device.

This creates a form of redundancy and/or independence for the two end positions of the vehicle seat. Additionally, the use of a second detection device allows for a clearer distinction between the different signals.

It may be provided that the first detector device and the second detector device are each designed as a Hall sensor.

Hall sensors typically respond to a magnetic field in a specific direction. Accordingly, Hall sensors have a detection direction in which they respond to a magnetic field. If the detection direction is reversed in relation to the magnetic field, the Hall sensor typically does not respond.

Since the permanent magnets are oriented differently, in other words, their magnetic poles are aligned oppositely to each other, a first Hall sensor can be positioned 180 degrees rotated relative to a second Hall sensor. Accordingly, the first Hall sensor can detect the state of the first permanent magnet, and the second Hall sensor can detect the state of the second permanent magnet, or the presence of each respective first and second permanent magnet.

The first Hall sensor and the second Hall sensor do not have to be arranged spatially separated from each other, but only opposite to each other in terms of their position, i.e., in terms of their detection direction.

The device can have at least a third permanent magnet and preferably a fourth permanent magnet. The third permanent magnet and the fourth permanent magnet are spaced apart from each other and their magnetic poles are aligned in opposite directions. In particular, their magnetic poles are arranged in a different spatial orientation to that of the first and second permanent magnets.

This allows for the detection of a neutral position, a first and second position, as well as a third and fourth position.

In other words, five discrete positions corresponding to five different displacement ranges can be detected. This makes it possible to control and activate an airbag with up to five stages.

It may be provided that a corresponding device has a third detector device and preferably a fourth detector device.

The third detector device and the fourth detector device can also be designed as Hall sensors. Similarly, their alignment must be adjusted in accordance with the orientation of the third and fourth permanent magnets, analogous to the arrangement described for the first Hall sensor and the second Hall sensor with the first and second permanent magnets.

Preferably, the third and fourth detection devices are arranged with opposing detection directions, particularly with detection directions that differ from those of the first and second detection devices.

Accordingly, the first to fourth detector devices can be arranged close to each other, in particular, in a common housing, whereby they do not influence each other and only one of the detector devices responds depending on the associated permanent magnet.

In one embodiment, however, it can also be provided that the first detector device and the second detector device are designed as Reed sensors.

Reed sensors are inexpensive and easy to train and evaluate, since they generate a signal that is either 0 or 1, i.e., defines a clear status.

When using Reed sensors, it may be arranged that the second detection device is laterally spaced from the first detection device along the direction of displacement. Correspondingly, the permanent magnets are preferably also laterally spaced from each other in the direction of displacement. This ensures that the first reed sensor only passes over the first permanent magnet and the second reed sensor only passes over the second permanent magnet. Theoretically, it is also conceivable to arrange the combination of the first Reed Sensor and the first permanent magnet on the first pair of upper and lower rails, and the combination of the second Reed Sensor and the second permanent magnet on the second pair of upper and lower rails.

Another aspect concerns a method for determining the position of a vehicle seat that can be moved linearly along a seat rail relative to the vehicle floor. In particular, this relates to a method for detecting the position of a vehicle seat using a device as described above. In the method, the position of a first permanent magnet and the position of a second permanent magnet are detected by means of a first detector device.

By detecting the first position of a permanent magnet and the position of a second permanent magnet, a section can be divided into three parts, as described above. The method includes a first part associated with the position of the first permanent magnet, a second part associated with the position of the second permanent magnet, and a third part located between the two permanent magnets, which is detected as neutral, i.e., without a signal. In other words, three discrete positions can be determined for each of three associated displacement ranges.

Alternatively, the position of the second permanent magnet can be detected by means of a second detector device. As already explained, detection with a second detector device can provide a signal that is independent of the first detector device.

It is particularly envisioned that the first and/or second detection device reads out magnet fields of the permanent magnets, which are oriented differently from each other. This allows for reliable control, since it can be clearly defined whether the first or second magnet is being read, and accordingly, a specific position can be assigned. This allows a clear and unambiguous determination of the position, or several positions, of a vehicle seat relative to the vehicle floor.

Generally speaking, the vehicle floor is a reference point for all elements of a vehicle. In particular, the position of the steering wheel is determined in relation to the vehicle floor. By shifting the vehicle seat relative to the vehicle floor, the relative position of the vehicle occupant to the steering wheel can also be determined. However, other factors can also have an influence. For example, the position of a vehicle seat backrest also has a significant influence on the distance between the vehicle occupant's head and the steering wheel. The position of the backrest can also be taken into account by measuring the angle, for example.

### BRIEF DESCRIPTION OF THE DRAWINGS

The inventive device and method are described using schematic figures. It shows:

FIG. 1: A vehicle seat;

FIG. 2: A seat rail;

FIG. 3A: A seat rail in a first position;

FIG. 3B: A seat rail in a neutral position;

FIG. 3C: A seat rail in a second position:

FIG. 4: A detailed view from FIG. 3B;

FIG. 5: A detailed view analogous to FIG. 4;

FIG. 6A: The functional principle in superimposed representation;

FIG. 6B: Signals analogous to the representation in FIG. 6A;

FIG. 7: An alternative embodiment.

### DETAILED DESCRIPTION OF THE PREFERRED EMBODIMENTS

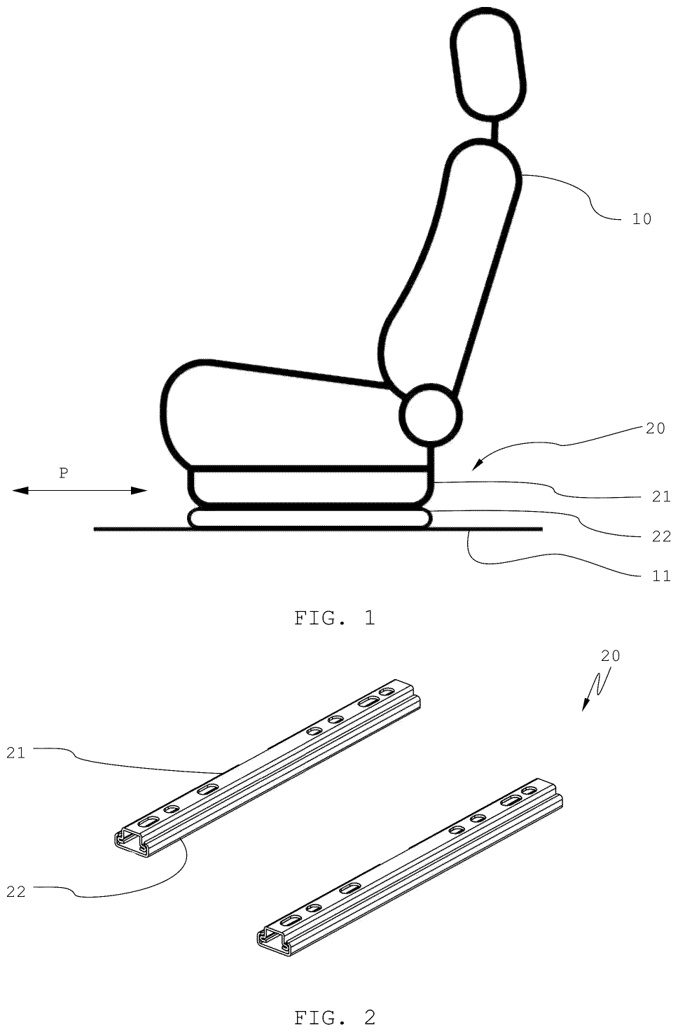

FIG. 1 shows a vehicle seat 10 arranged on a vehicle floor 11 by means of a seat rail 20. The seat rail 20 has an upper rail 21 and a lower rail 22. The bottom rail 22 is attached to the vehicle floor 11 and the top rail 21 can be moved linearly to the bottom rail 22 in the direction of the double arrow P. The double arrow P thus represents the direction of displacement.

FIG. 2 shows a basic representation of a conventional seat rail 20. The seat rail 20 has two pairs of an upper rail 21 and a lower rail 22. For the sake of clarity, only one pair is labeled with reference symbols. Two such pairs of top rail and bottom rail, as shown in FIG. 2, are typically used to attach a vehicle seat 10 (see FIG. 1).

In relation to the present description, the term seat rail is used, typically referring only to a pair of top rails 21 and bottom rails 22. However, it is understood that the seat rail 20 is typically in the configuration shown in FIG. 2.

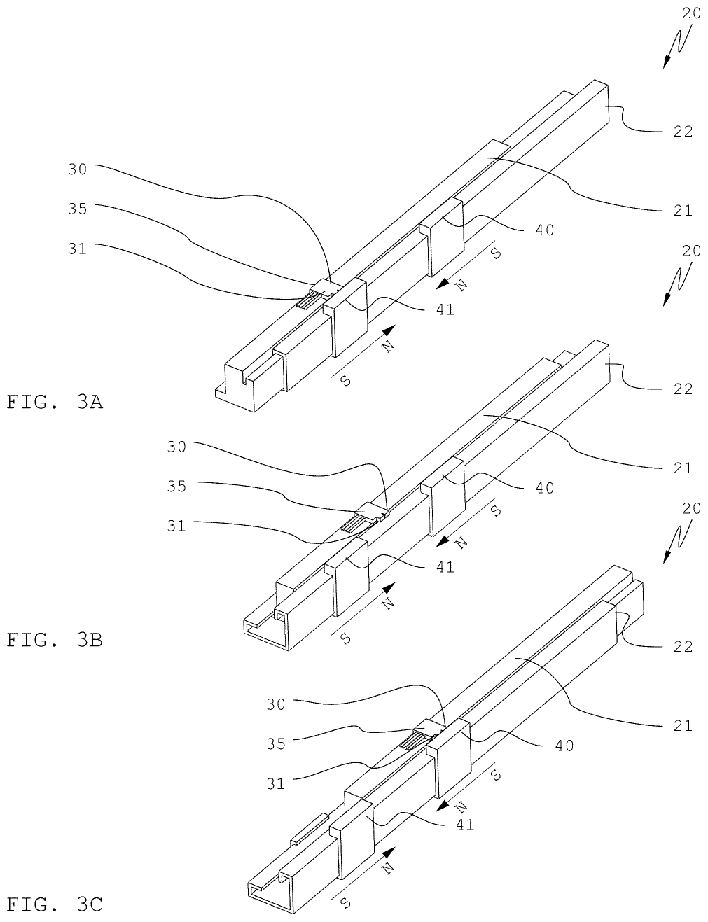

FIG. 3A shows a seat rail 20 in a first position. The seat rail 20 has an upper rail 21 and a lower rail 22. A first permanent magnet 40 and a second permanent magnet 41 are arranged on the bottom rail 22. On the upper rail 21, a first detection device 30 and a second detection device 31 are arranged within a housing 35.

The magnetic poles of the first permanent magnet 40 and the second permanent magnet 41 are aligned in opposite directions. In other words, in the present FIG. 3A, the permanent magnets 40 and 41 are arranged such that their north poles face each other. Alternatively, it would also be possible for their south poles to face each other. In FIG. 3A, the upper rail 21 is in its foremost position. In this setup, the housing 35 containing the first detection device 30 and the second detection device 31 passes over the second permanent magnet 41, allowing it to emit a corresponding signal for the entire length over which the detection device 31 sweeps across the permanent magnet 41, thus covering the associated displacement range. A corresponding signal output can be transferred to the control unit. In the position shown here, labeled “at the very front,” the airbag is accordingly deployed with a reduced charge. The exact mode of operation of the detection and signal output is explained separately below with reference to the following figures.

FIG. 3B shows a representation analogous to FIG. 3A of a seat rail 20 in a neutral position. The structure and the individual elements correspond to those in FIG. 3A and are not repeated for the sake of readability. As can be seen, the housing 35 with the first detector device 30 and the second detector device 31 is arranged between the first permanent magnet 40 and the second permanent magnet 41. Since the first and second detection devices 30 and 31 are located outside the influence range of the permanent magnets 40 and 41, there is no signal present for the entire area between these permanent magnets, corresponding to the associated displacement range. However, this “missing” signal can also be evaluated by a corresponding control unit so that a neutral position can be implied to the system. Accordingly, the airbag is deployed with a standard charge.

FIG. 3C shows the seat rail with the top rail 21 in its rearmost position. The structure and the individual elements correspond to those in FIG. 3A and are not repeated for the sake of readability. As can be seen, the housing 35 containing the first detection device 30 and the second detection device 31 passes over the first permanent magnet 40, allowing it to emit a corresponding signal for the entire length over which the detection device 31 sweeps across the permanent magnet 40, thus covering the associated displacement range. A corresponding signal output can be transferred to the control unit. In the position shown here, labeled “far back,” the airbag is accordingly deployed with an increased charge.

This means that three specific, essentially unchanging signals are output, each of which corresponds to a discrete position.

Of course, the housing 35 is completely optional in all the embodiments shown here.

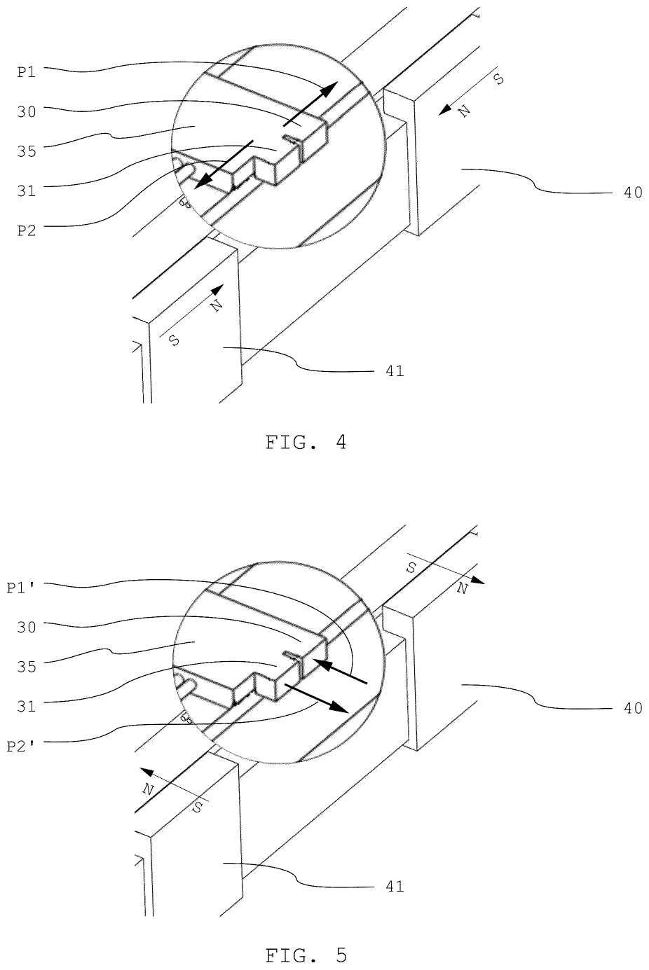

FIG. 4 shows a detailed view from FIG. 3B. The housing 35 containing the first detection device 30 and the second detection device 31 is shown enlarged. In the direction of movement of the seat rail 20 (see FIG. 1), the first permanent magnet 40 is aligned in a south-north direction, and the second permanent magnet 41 in a north-south direction. In other words, the permanent magnets 40 and 41 have opposite magnetic poles. Correspondingly, the first and second detection devices 30 and 31 are aligned in the same manner. The first and second detector devices 30 and 31 are Hall sensors which also have a dedicated detection direction. The detection directions of the Hall sensors are also aligned in opposite directions, as shown by the arrows P1 and P2.

It is evident that depending on the positioning of the Hall sensors, only one of the two Hall sensors will respond—the one that is activated by the appropriately oriented magnetic field, either north-south or south-north. Accordingly, no signal is present at the other Hall sensor, meaning it is not activated. FIG. 5 shows a detailed view similar to the detailed view in FIG. 4, but with an alternative alignment of the magnetic fields. Here too, the magnetic poles of the permanent magnets 40 and 41 are aligned in opposite directions. In contrast to the configuration shown in FIG. 4, the magnetic fields are arranged perpendicular to the direction of displacement. Correspondingly, the Hall sensors in the housing 35 are also arranged rotated by 90 degrees, but still with opposing detection directions P1′ and P2′. However, the functionality is fully equivalent to the operation described for FIG. 4.

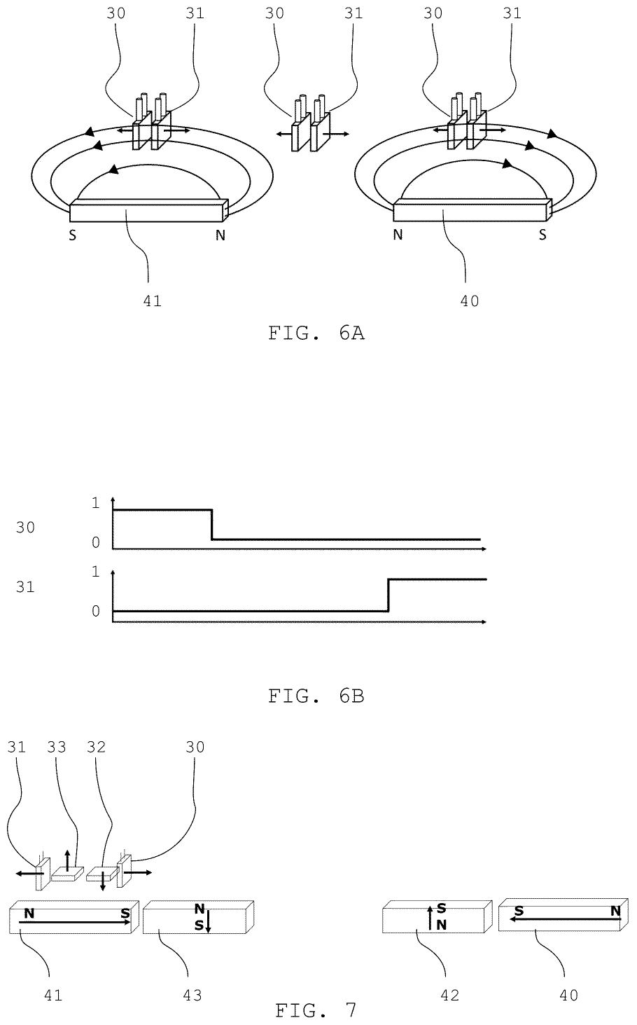

FIG. 6A shows the functional principle in a schematic diagram. All three positions are shown as in FIGS. 3A to 3C. On the left in FIG. 6A is the position of the detector devices corresponding to FIG. 3A. Both detection devices 30 and 31, currently designed as Hall sensors, are positioned within the magnetic field area. Since these two Hall sensors have opposite detection directions, as indicated by the arrows, only the Hall sensor 31 registers a signal. This is shown accordingly in FIG. 6B. The sensor 31 generates the signal 1. The middle two detection devices 30 and 31, specifically the corresponding Hall sensors, are depicted as per FIG. 3B. As can be seen, both sensors, or detection devices, are outside the influence range of a magnetic field. The corresponding signal output is shown in the middle section of FIG. 6B. Neither the first detector device 30 nor the second detector device 31 generate a signal. The right-hand side of FIG. 6A shows the state shown in FIG. 3C. The first and second detection devices, 30 and 31—specifically the corresponding Hall sensors—are within the influence area of the magnetic field of the first permanent magnet 40. Due to the opposing detection directions, only the Hall sensor of the first detection device, 30, is activated in this case. The corresponding signal curve is shown at the right end of FIG. 6B. Signal 1 is present at the first detection device 30 or is accordingly generated. In this case, no signal is present at the second detection device 31.

To determine the position of a vehicle seat 10 that can be moved linearly along a seat rail 20 relative to a vehicle floor 11 (see FIG. 1), the position of a first permanent magnet 40 and a second permanent magnet 41 is detected using a first detection device 30. A linear Hall sensor or a Hall sensor with two detection axes can be used for this purpose. In the former case, additional detection logic is provided that can evaluate a signal strength. In the latter case, the Hall sensor with two detection axes basically corresponds to two Hall sensors that integrally designed with different detection axes. Accordingly, this Hall sensor would have two outputs, whose switching schematic or signals are presented similarly to those shown in FIG. 6B.

Preferably, however, the position of the second permanent magnet 41 is detected by means of a second detector device 31, as described in FIGS. 6A and 6B.

The method is particularly based on the fact that the first and/or second detection devices 30 and 31 read magnetic fields of the permanent magnets 40 and 41 which are aligned differently from each other.

FIG. 7 shows an alternative embodiment of a device for detecting the position of a vehicle seat that can be moved linearly along a seat rail relative to a vehicle floor. The device according to FIG. 7 is essentially constructed similarly to the devices described in FIGS. 3A to 4 and 6A to 6B. However, a third permanent magnet 42 and a fourth permanent magnet 43 are positioned between the first permanent magnet 40 and the second permanent magnet 41. Essentially, the configuration of the device according to FIG. 5 is positioned between the first and second permanent magnets 40 and 41. Similarly, a third detector device 32 and a fourth detector device 33 are arranged between the first detector device 30 and the second detector device 31. The permanent magnets 40 to 43 each have opposing magnetic pole orientations in pairs. In addition, the orientation of the third and fourth permanent magnets 42 and 43 is different to the orientation of the first and second permanent magnets 40 and 41. The first to fourth detector devices 30 to 33 are aligned in the same way. These are preferably Hall sensors with correspondingly different detection directions. The detection directions are oppositely oriented in pairs, and furthermore, the detection directions of the first and second detection devices 30 and 31 are different from the detection directions of the third and fourth detection devices 32 and 33. Accordingly, this arrangement allows for the detection of four different positions, as well as an additional position where no signal is detected at any of the detection devices 30 to 33. This means that five specific, essentially unchanging signals are output, each of which corresponds to a discrete position. Accordingly, an airbag can be controlled with additional stages. This is particularly useful for airbags that are not equipped with an explosive propellant charge, but instead have a gas reservoir, for example, which is released into the airbag in a controlled manner.

1. A device (100) for detecting multiple, specifically at least three, preferably exactly three, discrete positions of a vehicle seat, the device comprising a seat rail (20) along which the vehicle seat is linearly movable relative to a vehicle floor, where the seat rail (20) includes a first rail and a second rail that are movable relative to each other, particularly an upper rail (21) and a lower rail (22) wherein a first detection device (30) is mounted on the first rail and a first permanent magnet (40) and a second permanent magnet (41) are mounted on the second rail, the first permanent magnet (40) and the second permanent magnet (41) are spaced apart in the direction of the seat's movement and their magnetic poles are oppositely oriented.

2. The device (100) according to claim 1, characterized in that wherein the first detection device (30) is designed as a linear Hall sensor or as a Hall sensor with two detection axes.

3. The device (100) according to claim 1, further comprising a second detector device (31) which is arranged on the first rail.

4. The device (100) according to claim 3, wherein the first detector device (30) and the second detection device (31) are designed as Hall sensors.

5. The device (100) according to claim 4, wherein the first detection device (30) and the second detection device (31) are arranged with detection directions opposite to each other.

6. The device (100) according to claim 1, wherein the device (100) includes at least a third permanent magnet (42) and preferably a fourth permanent magnet (43), which are spaced apart from each other and whose magnetic poles are oppositely oriented, especially arranged in a spatial orientation different from that of the first and the second permanent magnets (40, 41).

7. The device (100) according to claim 6, further comprising a third detection device (32) and preferably a fourth detection device (33).

8. The device (100) according to claim 7, wherein the third detection device (32) and the fourth detection device (33) are designed as Hall sensors.

9. The device (100) according to claim 8, wherein the third detection device (32) and the fourth detection device (33) are arranged with opposing detection directions, particularly with detection directions that differ from those of the first and second detection devices.

10. The device (100) according to claim 3, wherein the first detection device (30) and the second detection device (31) are designed as Reed sensors.

11. The device (100) according to claim 6, wherein the second detection device (31) is arranged laterally spaced from the first detection device along the direction of displacement.

12. A method for determining the position of a vehicle seat that can be moved linearly along a seat rail (20) relative to a vehicle floor, the method comprising detecting the position of a first permanent magnet (40) and a second permanent magnet (41) using a first detection device (30).

13. The method according to claim 12, further comprising detecting the position of the second permanent magnet (41) by means of a second detection device (31).

14. The method according to claim 12, wherein at least one of the first detection device and a second detection device (30, 31) read magnetic fields of the first and the second permanent magnets (40, 41) which are aligned differently to one another.
